(19) United States
(12) Patent Application Publication
(10) Pub. No.: US 2006/0019514 A1
(43) Pub. Date: Jan. 26, 2006

(54) Wiring fixing tool

(75) Inventor: Kazuma Sekiya, Tokyo (JP)

Correspondence Address: SMITH, GAMBRELL & RUSSELL, LLP, 1850 M STREET, N.W., SUITE 800, WASHINGTON, DC, 20036, US

(73) Assignee: Disco Corporation

(21) Appl. No.: 11/183,813

(22) Filed: Jul. 19, 2005

(30) Foreign Application Priority Data
Jul. 22, 2004 (JP) 2004-214442

(51) Int. Cl. H01R 12/00

(52) U.S. Cl. 439/76.2

(57) ABSTRACT

A wiring fixing tool comprising a body having a belt insertion hole for accepting a fastening belt, a male screw portion projecting from the body, and a turning-force transmission means formed on the body.

### FIELD OF THE INVENTION

The present invention relates to a wiring fixing tool for fixing wires such as harness or the like that are wired in a processing machine and the like.

### DESCRIPTION OF THE PRIOR ART

In the production process of a semiconductor device, a plurality of areas are sectioned by dividing lines called “streets” formed in a lattice pattern on the front surface of a disk-like semiconductor wafer, and a circuit (function element) such as IC or LSI is formed in each of the sectioned areas. Individual semiconductor chips are manufactured by cutting the semiconductor wafer along the dividing lines to divide it into the areas having the circuit formed therein. Cutting along the streets of the semiconductor wafer is generally carried out with a cutting machine called “dicer”. This cutting machine comprises a chuck table for holding a semiconductor wafer, a cutting means comprising a cutting blade for cutting a workpiece held on the chuck table, and a cutting-feed means for moving the chuck table and the cutting means relative to each other.

Since the above cutting machine is provided with a large number of electric appliances such as a pulse motor for driving the chuck table, the cutting-feed means, etc., a servo motor for rotary-driving the cutting blade, and the like, a harness for supplying electricity to the electric appliances is wired in the cutting machine. A wiring fixing tool is mounted on the base member of the machine to bundle harness and fix it in such a manner that it does not come into contact with a precision movable portion of the machine so as not to affect its operation. That is, as shown in FIG. 6, the wiring fixing tool 10 has a belt insertion hole 101 for accepting a fastening belt 11 and an attachment hole 102, and is attached to the base member 13 by screwing an attachment bolt 12 fitted in the attachment hole 102 into a threaded hole 131 formed in the base member 13 of the machine. And, the fastening belt 11 is inserted into the belt insertion hole 101 to bundle harness 14 therewith and fix it.

To install the wiring fixing tool 10 on the base member 13, however, the wiring fixing tool 10 must be held by one hand to align the attachment hole 102 with the threaded hole 131 formed in the base member 13, and the bolt 12 must be inserted into the attachment hole 102 and the threaded hole 131 and screwed into these holes with a screwdriver by the other hand. Thus, work efficiency is very low. Further, it involves a problem that when the bolt 12 is inserted into the attachment hole 102 of the wiring fixing tool 10 and the threaded hole 131, it may drop on a precision movable portion such as the chuck table or the cutting means to damage it.

### SUMMARY OF THE INVENTION

It is an object of the present invention to provide a wiring fixing tool which can be mounted on the base member by simple operation.

According to the present invention, the above object can be attained by a wiring fixing tool comprising a body having a belt insertion hole for accepting a fastening belt, a male screw portion projecting from the body, and a turning-force transmission means formed on the body.

Since the wiring fixing tool of the present invention comprises a body having a belt insertion hole for accepting a fastening belt, a male screw portion projecting from the body and a turning-force transmission means formed on the body, the male screw portion can be easily screwed into the threaded hole by holding the body to align the male screw portion with the threaded hole formed in the base member and turning the male screw portion by means of the turning-force transmission means. Thereby, the wiring fixing tool can be easily mounted on the base member. Further, since the male screw portion is integrated with the body of the wiring fixing tool constituted according to the present invention, there is no occurrence of dropping the bolt at the time when the wiring fixing tool is installed onto the base member unlike the prior art and hence, inconvenience caused by the dropping a bolt can be prevented.

### BRIEF DESCRIPTION OF THE DRAWINGS

FIG. 1 is a perspective view of a wiring fixing tool constituted according to an embodiment of the present invention;

FIG. 2 is a perspective view of a fastening belt to be inserted into a belt insertion hole formed in the body of the wiring fixing tool shown in FIG. 1;

FIGS. 3(a), 3(b) and 3(c) are explanatory diagrams showing the procedure of fixing harness by using the wiring fixing tool shown in FIG. 1 and the fastening belt shown in FIG. 2;

FIG. 4 is a perspective view of a wiring fixing tool according to another embodiment of the present invention;

FIG. 5 is a perspective view of a wiring fixing tool according to still another embodiment of the present invention; and

FIG. 6 is a sectional view showing a state where harness is fixed by the wiring fixing tool and the fastening belt of the prior art.

### DETAILED DESCRIPTION OF THE PREFERRED EMBODIMENTS

Preferred embodiments of the present invention will be described in detail hereinunder with reference to the accompanying drawings.

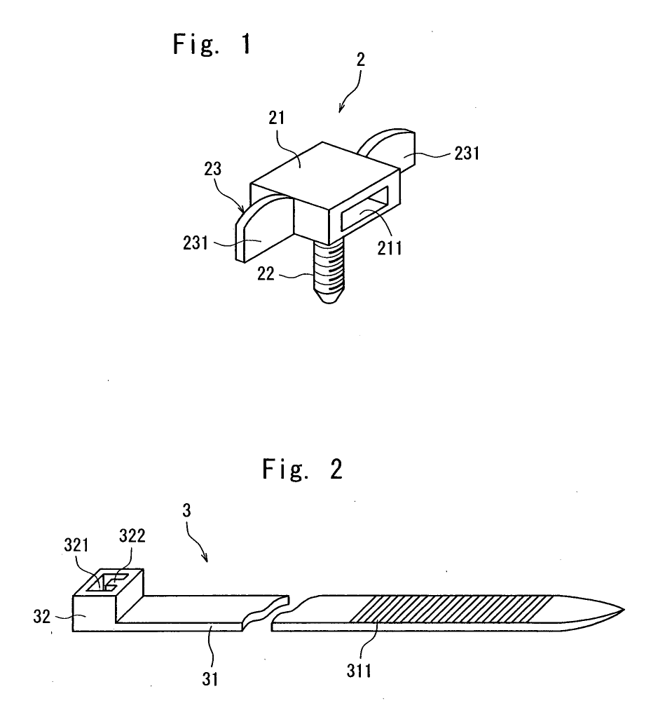

FIG. 1 is a perspective view of a wiring fixing tool constituted according to an embodiment of the present invention.

The wiring fixing tool 2 shown in FIG. 1 comprises a body 21, a male screw portion 22 projecting from the body 21, and a turning-force transmission means 23 formed on the body 21, all of which are molded from a suitable synthetic resin as an integrated unit. The body 21 is formed like a rectangular parallelpiped in the illustrated embodiment, and a belt insertion hole 211 for accepting a fastening belt 3 shown in FIG. 2 is formed in the body 21. The male screw portion 22 projects from one face (i.e., undersurface in the figure) of the body 21. The turning-force transmission means 23 consists of a pair of holding portions 231 and 231 projecting sideways from opposite side faces of the body 21 like wings in the illustrated embodiment. Therefore, the wiring fixing tool 2 having the turning-force transmission means 23 consisting of the pair of holding portions 231 and 231 is shaped like a wing bolt.

The fastening belt 3 to be inserted into the belt insertion hold 211 formed in the body 21 of the above wiring fixing tool 2 will be described with reference to FIG. 2.

The fastening belt 3 shown in FIG. 2 comprises a tongue portion 31 and a fastening portion 32 formed at one end of the tongue portion 31, all of which are molded from a suitable synthetic resin as an integrated unit. A plurality of engagement claws 311 are formed on one surface side of the tongue portion 31. Meanwhile, an insertion hole 321 extending through the tongue portion 31 is formed in the fastening portion 32, and an engagement claw 322 to be engaged with one of the plurality of engagement claws 311 formed on the tongue portion 31 is formed on the wall of the insertion hole 321. The above fastening belt 3 may have conventionally known constitution.

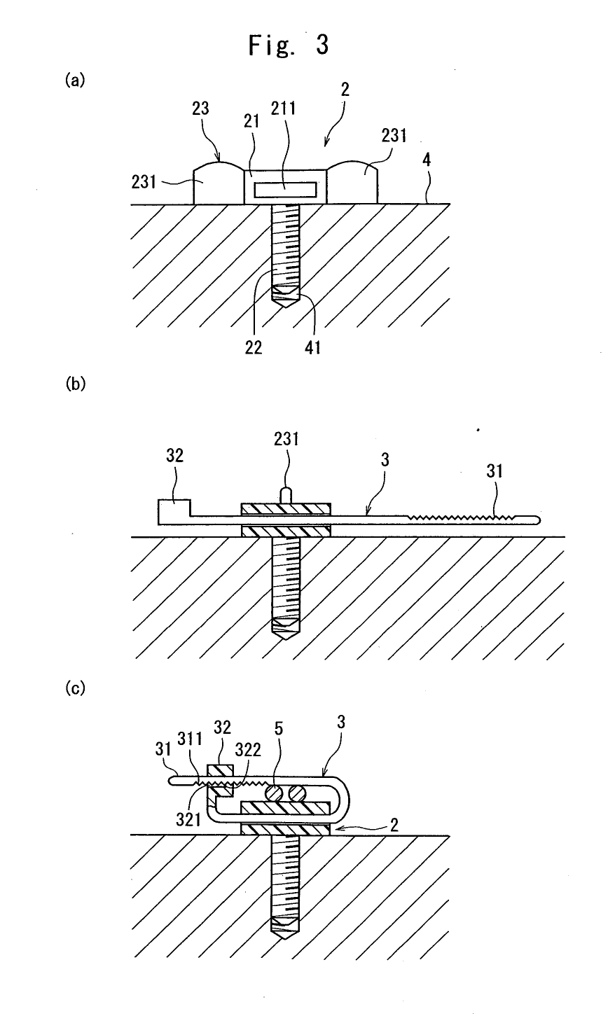

A description is subsequently given of the procedure of fixing harness with the above wiring fixing tool 2 and the fastening belt 3 with reference to FIGS. 3(a), 3(b) and 3(c).

As shown in FIG. 3(a), the male screw portion 22 of the wiring fixing tool 2 is first screwed into a threaded hole 41 formed in the base member 4 of a processing machine and the like. Here, the wiring fixing tool 2 can be easily mounted on the base member 4 by holding the pair of holding portions 231 and 231 constituting the turning-force transmission means 23 formed on the body 21 of the wiring fixing tool 2 to turn the wiring fixing tool 2. Further, since the body 21 of the wiring fixing tool 2 constituted according to the present invention is integrated with the male screw portion 22, a bolt does not drop at the time when the wiring fixing tool 2 is mounted on the base member 4 unlike the prior art, and inconvenience caused by the dropping of the bolt can be prevented. After the wiring fixing tool 2 is mounted on the base member 4, as shown in FIG. 3(b), the tongue portion 31 of the fastening belt 3 is inserted into the belt insertion hole 211 formed in the body 21 of the wiring fixing tool 2. Then, as shown in FIG. 3(c), harness 5 for supplying electricity to electric appliances provided in the processing machine or the like is bundled by the fastening belt 3, and the tongue portion 31 of the fastening belt 3 is inserted into the insertion hole 321. As a result, one of the engagement claws 311 formed on the tongue portion 31 is engaged with the engagement claw 322, and the harness 5 is thereby fixed to the wiring fixing tool 2 by means of the fastening belt 3.

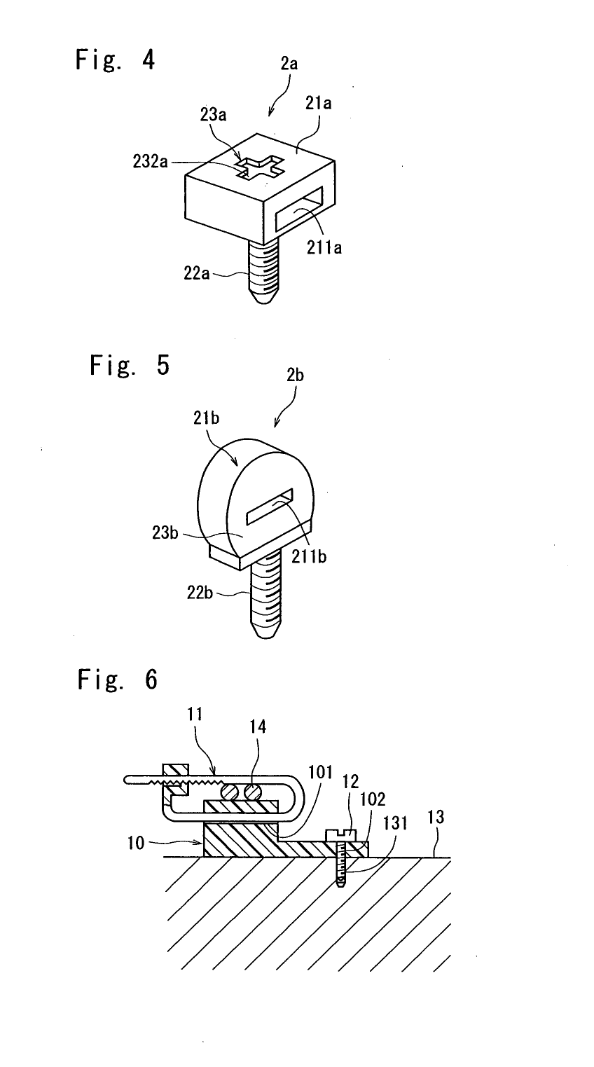

A description is subsequently given of wiring fixing tools constituted according to other embodiments of the present invention with reference to FIG. 4 and FIG. 5.

The wiring fixing tool 2a shown in FIG. 4 comprises also a body 21a having a belt insertion hole 211a, a male screw portion 22a projecting from one face (undersurface in the figure) of the body 21a and a turning-force transmission means 23a formed in the body 21a, all of which are molded from a suitable synthetic resin as an integrated unit, like those of the wiring fixing tool 2 shown in FIG. 1. The body 21a and the male screw portion 22a of the thus constituted wiring fixing tool 2a have substantially the same shapes as the body 21 and the male screw portion 22 of the wiring fixing tool 2 shown in FIG. 1, respectively. The turning-force transmission means 23a formed in the body 21a of the wiring fixing tool 2a shown in FIG. 4 differs from the turning-force transmission means 23 of the wiring fixing tool 2 shown in FIG. 1. That is, the turning-force transmission means 23a of the wiring fixing tool 2a shown in FIG. 4 is composed of a screwdriver fitting groove 232a formed in a face (top face in the figure) opposite to the face, on which the male screw portion 22a is formed, of the body 21a. Therefore, the end of a screwdriver is fitted into the screwdriver fitting groove 232a formed in the body 21a and the male screw portion 22a is easily screwed into the threaded hole formed in the base member by turning the screwdriver.

The wiring fixing tool 2b shown in FIG. 5 is formed in a shape that part of the peripheral portion of a disk-like body 21b having a belt insertion hole 211b is cut away, and a male screw portion 22b projects from the plane of the cut-away peripheral portion. In the wiring fixing tool 2b shown in FIG. 5, the disk-like body 21b itself constitutes a turning-force transmission means 23b as a holding portion. Therefore, the male screw portion 22b can be easily screwed into the threaded hole formed in the base member by holding the disk-like body 21b to align the male screw portion 22b with the threaded hole formed in the base member and turning the body 21b.

What is claimed is:

1. A wiring fixing tool comprising a body having a belt insertion hole for accepting a fastening belt, a male screw portion projecting from the body, and a turning-force transmission means formed on the body.
